(19) United States
(12) Patent Application Publication
(10) Pub. No.: US 2006/0289580 A1
(43) Pub. Date: Dec. 28, 2006

(54) Receiver hitch rack system

(75) Inventors: Lloyd Faver, Keller, TX (US); Glenn Larson, Fort Worth, TX (US)

Correspondence Address: Robert C. Shaddox;Winstead Sechrest & Minick P.C., P.O. Box 50784, Dallas, TX, 75201, US

(73) Assignee: GLF Innovations, L.L.C., Fort Worth, TX (US)

(21) Appl. No.: 11/136,286

(22) Filed: May 24, 2005

Related U.S. Application Data
(60) Provisional application No. 60/573,987, filed on May 24, 2004.

(51) Int. Cl. B60D 1/07; B60D 1/14; B60R 11/00; B60R 9/00

(52) U.S. Cl. 224/521; 224/924; 280/416.1; 280/495

(57) ABSTRACT

A receiver hitch rack system and apparatus for providing storage of receiver hitch devices in a clean, safe, stable, and organized manner. The receiver hitch rack system and apparatus comprises a mounting device and a mounting base, wherein the mounting device may be removably attached to the mounting base, and wherein the mounting base may be attached to a structural support, which includes, but is not limited to, a stud wall, a tool box, a vehicle and a fence. The receiver hitch devices are inserted or fastened onto the mounting device, preferably tube-shaped. The receiver hitch rack system and apparatus may be stored in a vertical or horizontal manner depending upon the receiver hitch device's configuration and the space available.

The objective of this invention is to provide a clean, safe, stable and organized manner in which to store all objects that attach into a standard receiver hitch. Invention could be utilized in an unlimited number of locations ie. Garages, sheds, vehicles, barns etc.

The invention consists of a metal tube acting as a female receiver in which receiver hitch devices (many shapes & configurations) may be inserted and or fastened to. The invention will then mount into a mounting base attached to a structural support (stud wall, Gladiator Wall, tool box, vehicle, headache rack, fence etc.) Once the mounting base is attached to the structural support it will then provide a clean, safe, stable and organized storage of receiver hitch devices. Depending on the configuration of the receiver device being stored, it may be stored in a vertical or horizontal orientation to maximize the effectiveness of the invention and the space in which it is applied.

As can be appreciated from the attached figures, many variations are possible, both for the configuration of the attachment to the wall, and as to the orientation of the receiver hitch devices. It should especially be appreciated that any device configured for mounting to a vehicle receiver hitch can be mounted to a wall or other structure to which the receiver rack hitch system of the present invention is attached. All such receiver hitch devices are contemplated as within the scope of the present invention. By way of example and not limitation, the present invention is adaptable to mount a vehicle bicycle rack to the wall, thus providing storage for both the rack, and the bicycles. Other devices such as portable coolers and the corresponding receiver carrier trays could also be stored in a like manner. Additionally, the device is adaptable for other items such as saddles or other tack.

### BRIEF DESCRIPTION OF THE SEVERAL VIEWS OF THE DRAWING

The summary as well as the detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention.

The invention may take physical form in certain parts and arrangement of parts. For a more complete understanding of the present invention, and the advantages thereof, reference is now made to the following descriptions taken in conjunction with the accompanying drawings, in which:

FIG. 1 depicts an overview of a receiver rack hitch system with several types of receiver hitch devices mounted thereon according to one embodiment of the present invention.

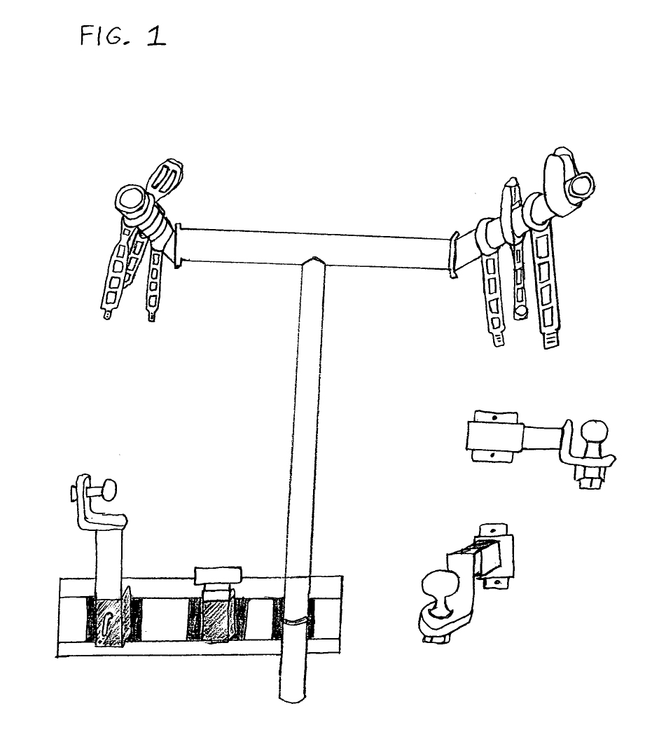

FIG. 2 depicts an angled view of a mounting base according to one embodiment of the present invention.

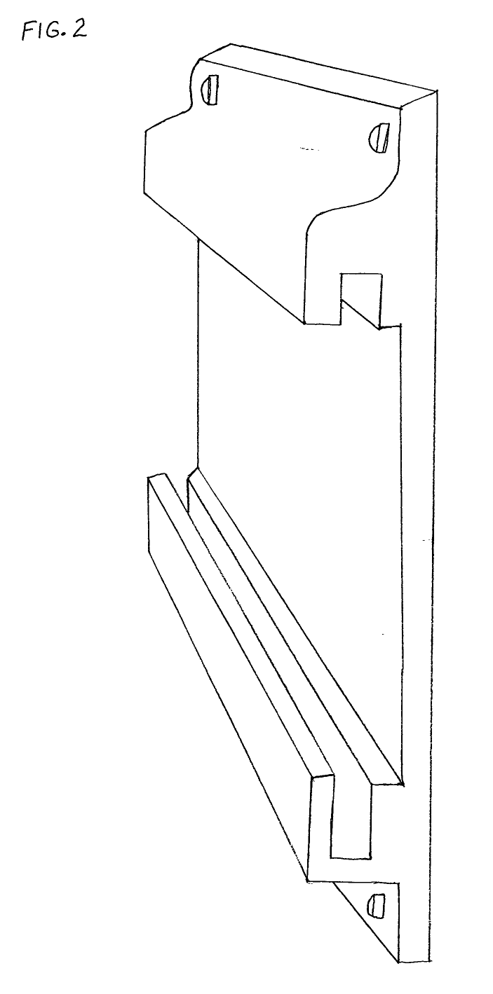

FIG. 3 illustrates an angled view of a receiver bitch system having a mounting base with two female receivers according to one embodiment of the present invention.

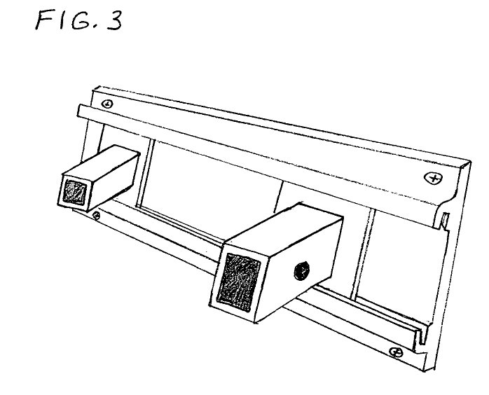

FIG. 4 illustrates an angled view of a receiver hitch system with two similar receiver hitch devices mounted thereon in a protruding horizontal manner according to one embodiment of the present invention.

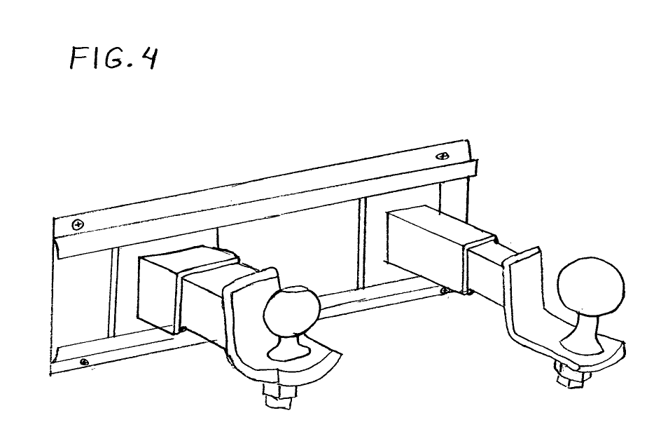

FIG. 5 shows an angled view of a receiver hitch system with two similar receiver hitch devices mounted thereon in a vertical upward manner according to one embodiment of the present invention.

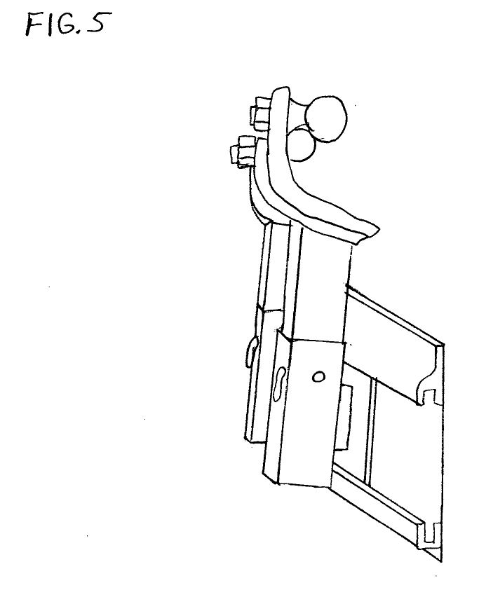

FIG. 6 shows a frontal view of a receiver hitch system with two similar receiver hitch devices mounted thereon in a planar horizontal manner according to one embodiment of the present invention.

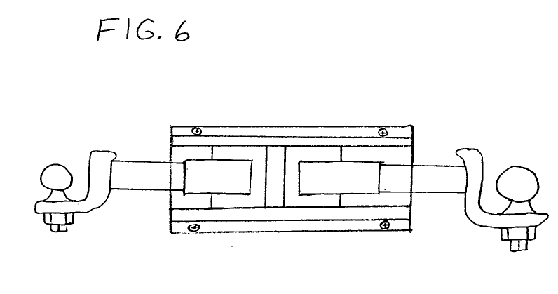

FIG. 7 depicts a frontal view of a receiver hitch system with different receiver hitch devices mounted thereon in a vertical upward manner according to one embodiment of the present invention.

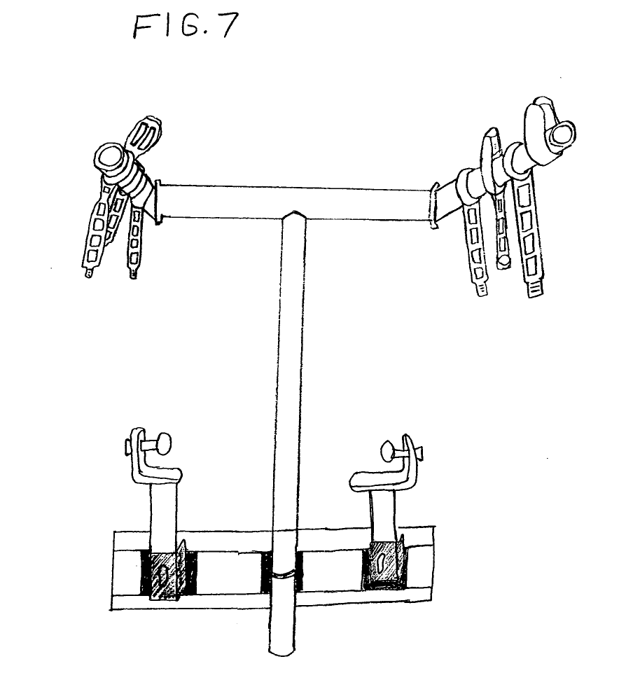

FIG. 8 depicts a frontal view of a receiver hitch system with different receiver hitch devices mounted thereon in a vertical upward manner with a bicycle mounted to one of the receiver hitch device according to one embodiment of the present invention.

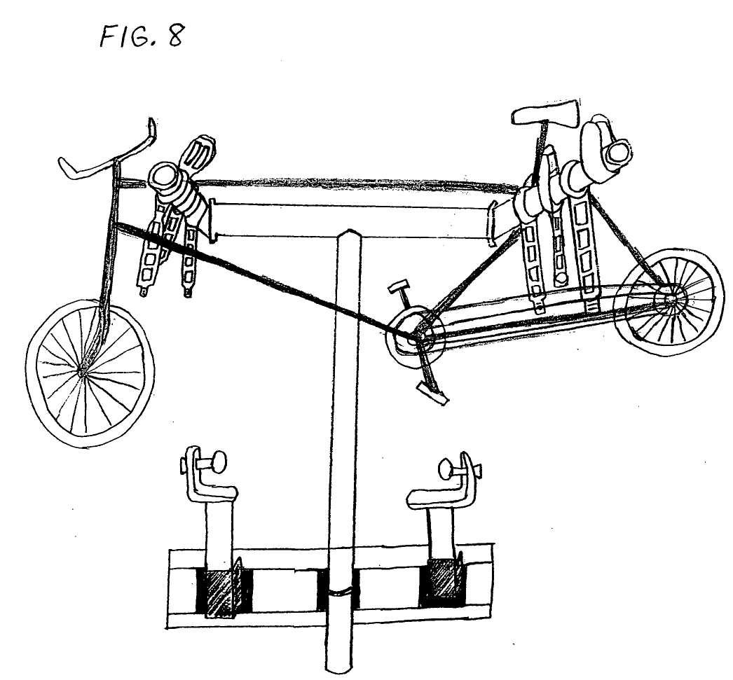

FIG. 9 illustrates a frontal view of a receiver hitch system with different receiver hitch devices mounted thereon in a vertical upward manner with two bicycles mounted to one of the receiver hitch device according to one embodiment of the present invention.

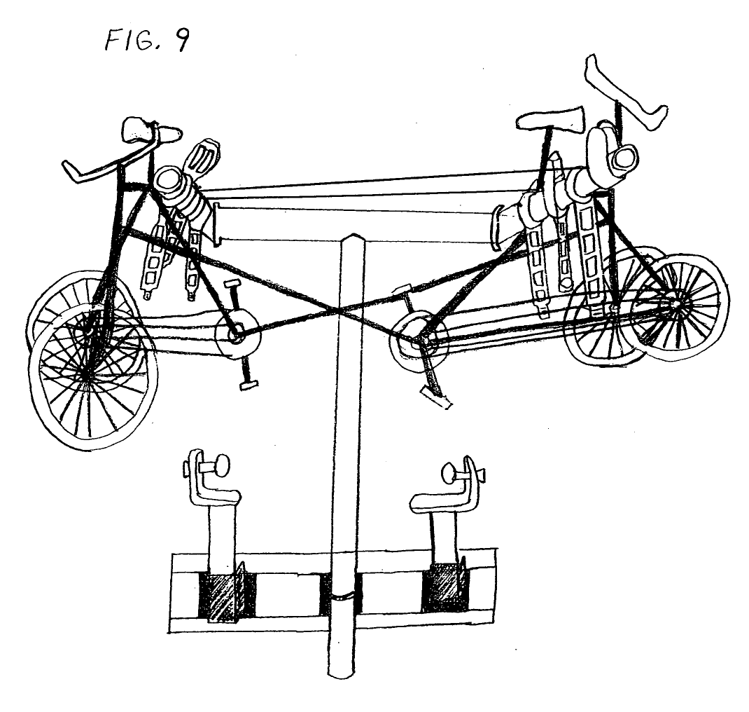

FIG. 10 illustrates an angled view of a receiver hitch system with three similar receiver hitch devices mounted thereon in a vertical upward manner according to one embodiment of the present invention.

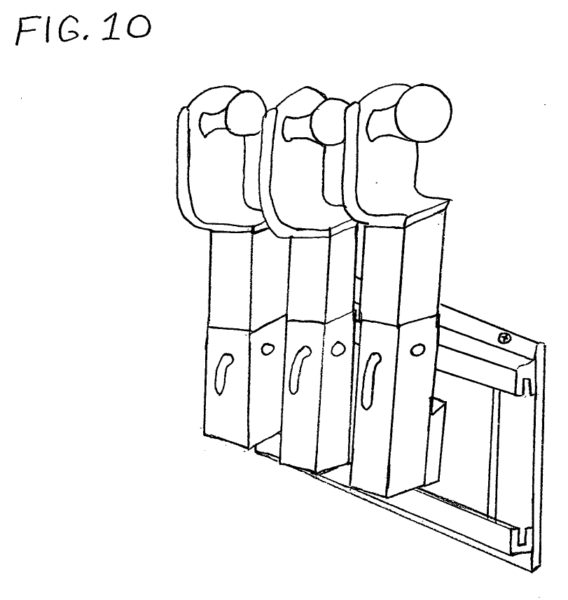

FIG. 11 shows a frontal view of a receiver hitch system with three similar receiver hitch devices mounted thereon in a vertical downward manner and a horizontal planar manner according to one embodiment of the present invention.

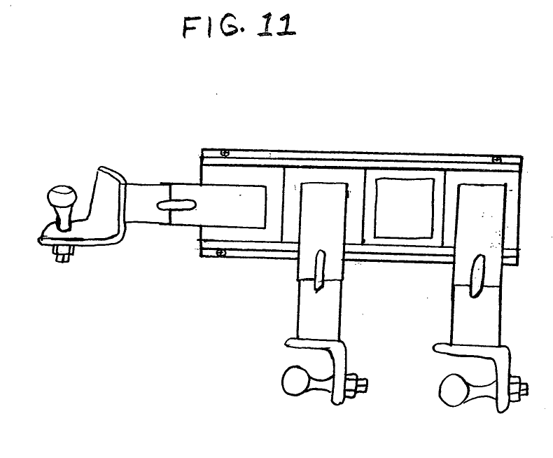

FIG. 12 shows a frontal view of a receiver hitch system with three similar receiver hitch devices mounted thereon in a vertical downward manner and a horizontal planar manner according to one embodiment of the present invention.

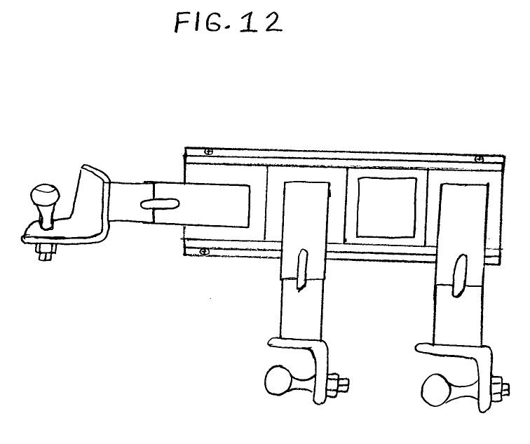

FIG. 13 depicts a frontal view of a receiver hitch system with three similar receiver hitch devices mounted thereon in a vertical upward manner according to one embodiment of the present invention.

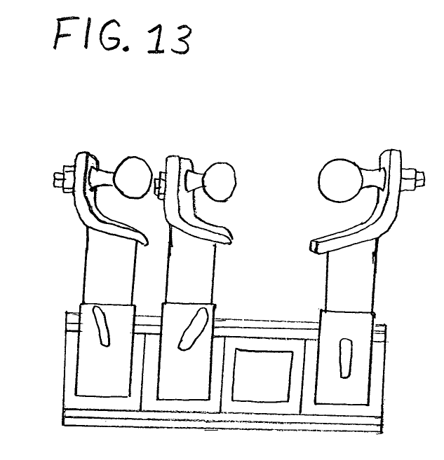

FIG. 14 depicts a frontal view of two female receivers mounted to a wall and having a receiver hitch device mounted thereon according to one embodiment of the present invention.

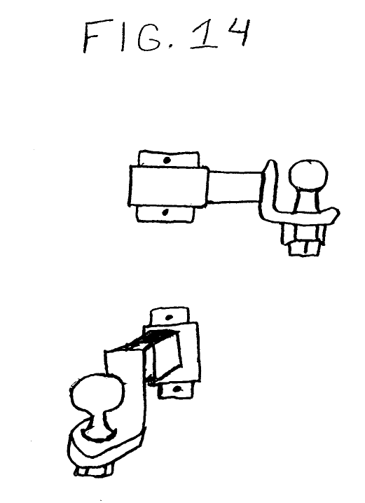

FIG. 15 illustrates an angled view of a receiver hitch system with two differently oriented female receivers mounted thereon according to one embodiment of the present invention.

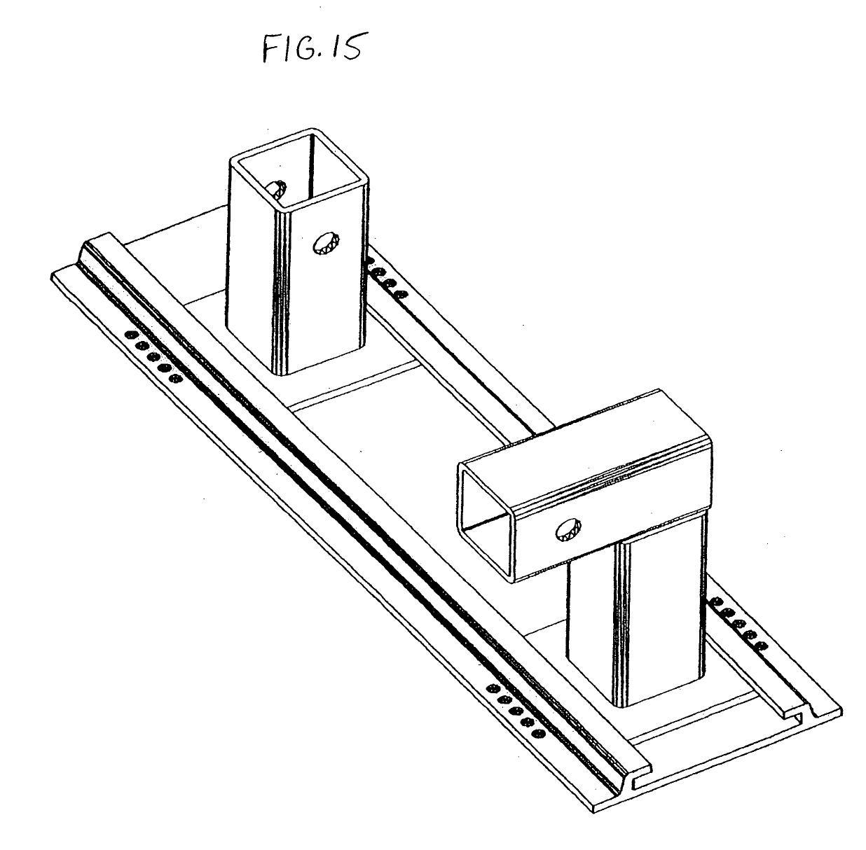

1. A mounting and at least one receptacle device for interlocking connection with said mounting, wherein said receptacle is adapted to receive a vehicle receiver hitch mountable device, for storage of said device.

2. The invention of claim 1 further adapted to provide storage of any object configured to mount on said receiver hitch mountable device.

3. The device as shown and described in the accompanying figures and description.
